(19) United States
(12) Patent Application Publication
(10) Pub. No.: US 2026/0023634 A1
(43) Pub. Date: Jan. 22, 2026

(54) TECHNIQUES FOR VIRTUAL PRIVATE CLOUD FLOW LOGS AGGREGATION

(71) Applicant: Wiz, Inc., New York, NY (US)

(72) Inventors: Yehonatan AMNON HORNSTEIN, Tel Aviv (IL); Itay HAREL, Tel Aviv (IL)

(73) Assignee: Wiz, Inc., New York, NY (US)

(21) Appl. No.: 18/779,911

(22) Filed: Jul. 22, 2024

(51) Int. Cl. G06F 11/07

(52) U.S. Cl. CPC G06F 11/0787; G06F 11/0781

(57) ABSTRACT

A method for generating and storing an aggregated flow log is presented. The method includes: accessing a plurality of flow log records in a repository; detecting a plurality of records in the repository, wherein each flow log record includes a plurality of data fields; detecting a first flow log record of the plurality of flow log records having a first data field value in common with a second flow log record; detecting in the first flow log record a second data field having a second value; detecting in the second flow log record the second data field having a third value; generating a merged record based on: the first data field value, the second value and the third value; generating an aggregated flow log based on the merged record, wherein the aggregated flow log includes a plurality of merged records; and storing the aggregated flow log in a repository.

### TECHNICAL FIELD

The present disclosure generally relates to the monitoring of computer networks, and specifically to monitoring flow log streams of a virtual private cloud.

### BACKGROUND

A cloud computing event log is a comprehensive record of activities and operations within a cloud environment, capturing details like user logins, API requests, system errors, and configuration changes. Each entry is timestamped, providing precise timing for every event. These logs are essential for monitoring, troubleshooting, and auditing purposes, offering insights into the system's behavior and security.

However, the extensive nature of these logs can present significant challenges, especially as they grow large over time. The sheer volume of data can make it difficult to store, manage, and analyze logs efficiently. Large logs require substantial storage resources and can slow down the retrieval and processing of relevant information. Moreover, identifying significant events amid a vast amount of routine activity can be like finding a needle in a haystack, complicating efforts to detect anomalies or troubleshoot issues quickly. Effective log management strategies and tools are therefore crucial to handle the scale, ensuring that valuable insights can be extracted without being overwhelmed by the sheer quantity of data.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, method may include accessing a plurality of flow log records in a flow log repository. Method may also include detecting a plurality of flow log records in the flow log repository, where each flow log record includes a plurality of data fields; detecting a first flow log record of the plurality of flow log records having a first data field value in common with a second flow log record; detecting in the first flow log record a second data field having a second value; detecting in the second flow log record the second data field having a third value; generating a merged record based on: the first data field value, the second value and the third value; generating an aggregated flow log based on the merged record, where the aggregated flow log includes a plurality of merged records. Method may furthermore include storing the aggregated flow log in an aggregated flow log repository. Other embodiments of this aspect include corresponding computer systems, apparatus, and computer programs recorded on one or more computer storage devices, each configured to perform the actions of the methods.

Implementations may include one or more of the following features. Method may include: matching a data record value of the first flow log record to a corresponding data record value of another flow log record to detect a common data field value. Method may include: generating a merged record in response to detecting at least one common data record value between a plurality of flow log records from the flow log repository. Method may include: generating an aggregated flow log that includes common data record values from the merged records. Method where the first data field includes any one of: an account identifier, a source address, a protocol, a destination address, a source port, a destination port, a network interface, an instance identification log status, an indicator of whether the network traffic was accepted or rejected, a subnet identifier, and any combination thereof. Method may include: detecting a flow log record that is based on any one of: a data record, a network traffic event, a message, an action in a virtual private cloud environment, and any combination thereof. Method may include: generating the aggregated flow log based on a plurality of merged records, where a first merged record is generated from a first flow log and a second merged record is generated from a second flow log. Method may include: determining that a first data field value is common in response to detecting at least a partial match between a value of the first flow log record and a value of the second flow log record. Method may include: filtering out a portion of records of the plurality of data records based on a value of a data field; and generating the aggregated flow log based on the merged record without the filtered portion of records. Implementations of the described techniques may include hardware, a method or process, or a computer tangible medium.

In one general aspect, non-transitory computer-readable medium may include one or more instructions that, when executed by one or more processors of a device, cause the device to: access a plurality of flow log records in a flow log repository. Medium may furthermore include detect a plurality of flow log records in the flow log repository, where each flow log record includes a plurality of data fields detect a first flow log record of the plurality of flow log records having a first data field value in common with a second flow log record detect in the first flow log record a second data field having a second value detect in the second flow log record the second data field having a third value generate a merged record based on: the first data field value, the second value and the third value generate an aggregated flow log based on the merged record, where the aggregated flow log includes a plurality of merged records. Medium may moreover include store the aggregated flow log in an aggregated flow log repository. Other embodiments of this aspect include corresponding computer systems, apparatus, and computer programs recorded on one or more computer storage devices, each configured to perform the actions of the methods.

In one general aspect, system may include one or more processors configured to: access a plurality of flow log records in a flow log repository. System may furthermore detect a plurality of flow log records in the flow log repository, where each flow log record includes a plurality of data fields. System may in addition detect a first flow log record of the plurality of flow log records having a first data field value in common with a second flow log record. System may moreover detect in the first flow log record a second data field having a second value. System may also detect in the second flow log record the second data field having a third value. System may furthermore generate a merged record based on: the first data field value, the second value and the third value. System may moreover generate an aggregated flow log based on the merged record, where the aggregated flow log includes a plurality of merged records. System may also store the aggregated flow log in an aggregated flow log repository. Other embodiments of this aspect include corresponding computer systems, apparatus, and computer programs recorded on one or more computer storage devices, each configured to perform the actions of the methods.

Implementations may include one or more of the following features. System where the one or more processors are further configured to: match a data record value of the first flow log record to a corresponding data record value of another flow log record to detect a common data field value. System where the one or more processors are further configured to: generate a merged record in response to detecting at least one common data record value between a plurality of flow log records from the flow log repository. System where the one or more processors are further configured to: generate an aggregated flow log that includes common data record values from the merged records. System where the first data field includes any one of: an account identifier, a source address, a protocol, a destination address, a source port, a destination port, a network interface, an instance identification log status, an indicator of whether the network traffic was accepted or rejected, a subnet identifier, and any combination thereof. System where the one or more processors are further configured to: detect a flow log record that is based on any one of: a data record, a network traffic event, a message, an action in a virtual private cloud environment, and any combination thereof. System where the one or more processors are further configured to: generate the aggregated flow log based on a plurality of merged records, where a first merged record is generated from a first flow log and a second merged record is generated from a second flow log. System where the one or more processors are further configured to: determine that a first data field value is common in response to detecting at least a partial match between a value of the first flow log record and a value of the second flow log record. System where the one or more processors are further configured to: filter out a portion of records of the plurality of data records based on a value of a data field; and generate the aggregated flow log based on the merged record without the filtered portion of records. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example schematic diagram of a cloud computing environment including a flow log aggregator, implemented in accordance with an embodiment.

FIG. 2 is an example identifiers diagram of a generated flow log, implemented in accordance with an embodiment.

FIG. 3 is an example identifiers diagram of an aggregated flow log generated by the flow log aggregator, implemented in accordance with an embodiment.

FIG. 4 is an example flowchart of a method for generating and storing an aggregated flow log, implemented in accordance with an embodiment.

FIG. 5 is an example schematic diagram of a flow log aggregator, implemented in accordance with an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

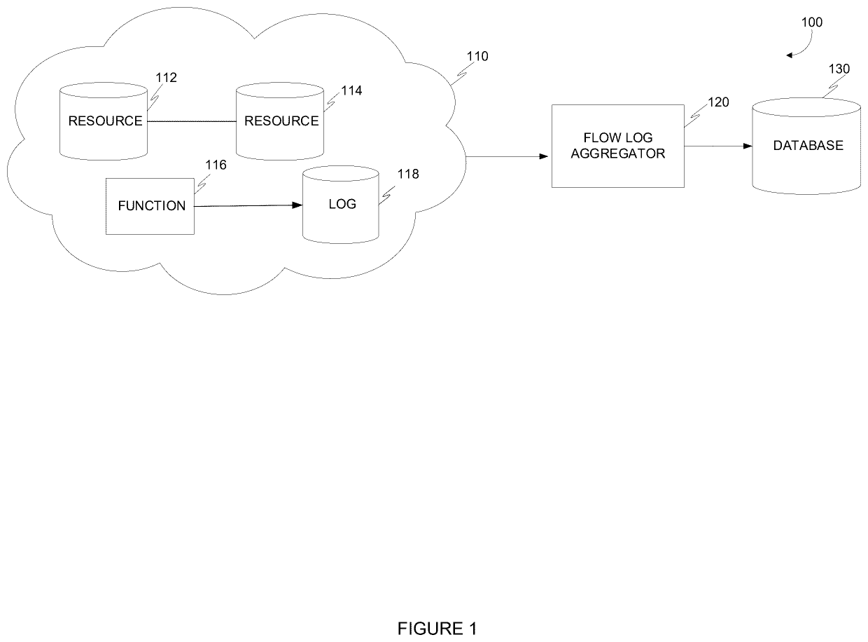

FIG. 1 is an example schematic diagram of a flow log aggregator 120 in a cloud computing environment 110, implemented in accordance with an embodiment. In an embodiment, the cloud computing environment 110 includes a plurality of resources, such as first resource 112, a second resource 114, a serverless function 116, and a log 118. In an embodiment, a flow log aggregator 120 is configured to access the log 118, and a database 130.

In an embodiment, a cloud computing environment 110 is implemented as a virtual private cloud (VPC), Virtual Network (VNet), virtual private network (VPN) and the like. A cloud computing platform is implemented on a cloud computing infrastructure, for example, such as Amazon® Web Services (AWS), Google Cloud Platform® (GCP), Microsoft® Azure, and the like.

In an embodiment, a cloud computing environment 110 includes cloud entities deployed therein. According to an embodiment, a cloud entity is, for example, a principal, a plurality of resources, such as first resource 112, a second resource 114, a combination thereof, and the like. In an embodiment, a first resource 112 and a second resource 114, are cloud entities that provide access to a compute resource, such as a processor, a memory, storage, and the like.

In some embodiments, a first resource 112 and a second resource 114, are virtual machines, software containers, serverless functions, and the like. According to certain embodiments, a first resource 112 and a second resource 114, include a software application deployed thereon, such as a webserver, a gateway, a load balancer, a web application firewall (WAF), an appliance, various combinations thereof, and the like.

In an embodiment, a cloud entity is a principal relative to another cloud entity and a first resource 112 to other cloud entities. In another embodiment, a cloud entity is a principal relative to another cloud entity and a second resource 114, to other cloud entities. For example, a load balancer is a first resource 112 to a user account requesting a webpage from a webserver behind the load balancer, and the load balancer is a principal to the webserver. In another example, a load balancer is a second resource 114, to a user account requesting a webpage from a webserver behind a load balancer, and the load balancer is a principal to the webserver. In some embodiments, a first resource 112 and a second resource 114 are configured to communicate with each other via an internal bus, data bus, Local Area Network (LAN), inter-process communication (IPC), Application Programming Interfaces (APIs), and the like.

In certain embodiments, the function 116 is a serverless function which is configured to detect data, such as network communication data. In an embodiment, the function 116 is configured to generate flow log records from communication traffic going to and from network interfaces in a Virtual Private Cloud (VPC).

In an embodiment, the function 116 is configured to generate flow logs based on data from communication traffic, including events, messages, detected event history within a specified time frame, and the like. In various embodiments, the communication traffic includes request events, messages, and response events, messages, a combination thereof, and the like. In certain embodiments, the flow log records include data record values which identify any one of: account identification numbers, source Internet Protocol (IP) addresses, destination IP addresses, protocol, source ports, destination ports, Elastic Network Interface, Instance ID, a combination thereof, and the like. For an example, in an embodiment, the function 116 is an Amazon Lambda serverless function which is configured to write events to Amazon® CloudTrail.

In an embodiment, the function 116 is configured to write events to a log 118, stored for example using a bucket, which is configured to store the generated flow log records from the function 116. In some embodiments, the log 118 includes a software tool, a software application, and the like, for collecting, parsing, manipulating, storing, etc., the generated flow log records.

In certain embodiments, flow log records contain data such as account identifiers, source Internet Protocol (IP) addresses, destination (IP) addresses, source port values, destination port values, log status, and indicators of whether the network traffic was accepted or rejected, and the like. In certain embodiments, the log 118 is an Amazon® Simple Storage Service (Amazon® S3) bucket, or any other object storage device or service. In an embodiment, a flow log record is generated based on a predetermined data schema.

In various embodiments, a flow log aggregator 120 is configured to access the log 118 to read the generated flow log records in the flow log repository stored on the log 118. In an embodiment, the flow log aggregator 120 is configured to access the flow log records in the flow log repository of the log 118. In some embodiments, the aggregator 120 is configured to detect flow log records from the flow log repository that can be merged, for example based on a predefined heuristic.

In an embodiment, each flow log record contains data record values. In some embodiments, each flow log record includes data record values which identify any one of: an account identifier, a source Internet Protocol (IP) address, a destination IP address, a protocol, a source port, a destination port, an Elastic Network Interface, an instance ID, a combination thereof, and the like. In an embodiment, the flow log aggregator 120 is configured to generate a merged flow log record in response to detecting multiple flow log records having at least one common data record value.

For example, in an embodiment, a common data record value is detected where a data record value of a first flow log record matches a corresponding data record value of another flow log record. For example, the flow log aggregator 120 is configured to detect a first flow log record and a second flow log record which share the same account identification number, source IP, destination IP, destination port, and the like. In some embodiments, the flow log aggregator 120 is configured to generate a merged record based on the detected matching data record values. In various embodiments, the flow log aggregator 120 will generate an aggregated flow log based on the merged records.

For example, in an embodiment, the aggregated flow log 120 is configured to store a single merged data record value for the account identification number, source IP value, destination IP value, and destination port number based on the common data record values of the first flow log and second flow log. For example, in an embodiment, where the source IP value is 10.0.0.2 for multiple records, the single merged data record value is ‘10.0.0.2’.

In certain embodiments, where there are different data record values for corresponding data fields of the first flow log record and the second flow log record, the aggregator 120 is configured to generate an aggregated data record value. For example, in an embodiment, where the source port is ‘4567’ in a first flow log record, and ‘7899’ in a second flow log record, the merged data record includes: the first value, the second value, or a combination thereof. In an embodiment, for example, an aggregate data value is generated from different data record values and stored as an array containing each different data record value from each one of the flow log records.

Therefore, the flow log aggregator 120 reduces the vast amount of flow log records and data stored in a database as well as storage cost by generating merged records and storing only the merged records in a database. In another embodiment, the flow log aggregator 120 enriches the aggregated records with additional metadata pertaining to detected events, data, and information from communication traffic (e.g. destination IP addresses associated with a geographical location).

In an embodiment, the database 130 (e.g. flow log repository) is configured to store the aggregated flow records generated from the flow log aggregator 120. A database 130 is a collection of data that is organized, accessed, and stored in a computer system. In an embodiment, the database 130 is managed through a database management system (DBMS), which is a software used to manage the data.

In another embodiment, the database 130 is a cloud database which is deployed to run in a public or hybrid cloud environment and is managed by database-as-a-service (DBaaS) or deployed in a cloud-based virtual machine (VM). In certain embodiments, the database 130 is implemented using a Snowflake® platform, data lake, data warehouse, and the like, which is designed for cloud environments and leverages the storage and computing power of cloud infrastructure, and furthermore utilizes a unique structured query language (SQL) query engine.

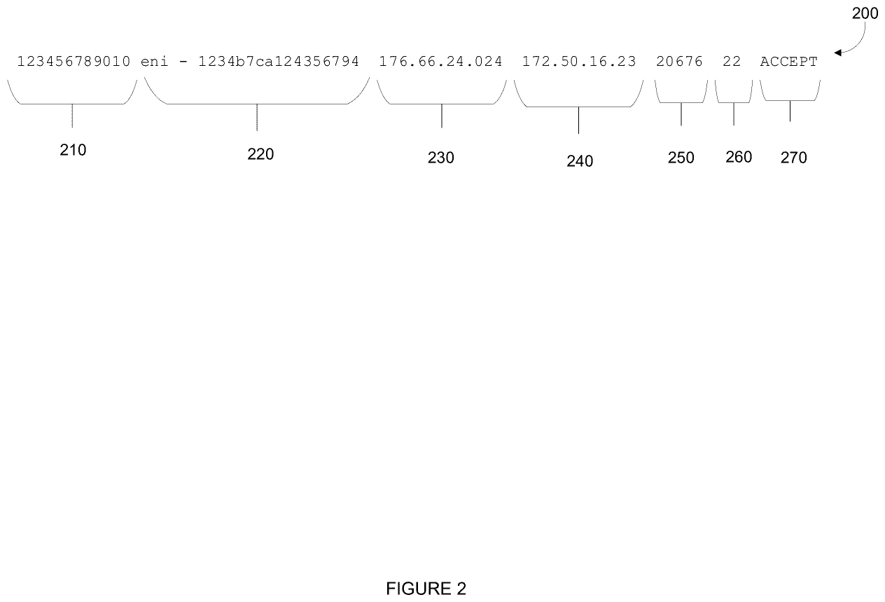

FIG. 2 is an example diagram 200 of a data record of a flow log, utilized to describe an embodiment. In various embodiments, the function 116 of FIG. 1 is configured to generate flow logs based on collecting data packets which contain data related to detected events, messages, from communication traffic going to and from network interfaces in a computing environment, such as a VPC.

In an embodiment, a packet analyzer (e.g. sniffer) is configured to read the data packets, and extract metadata values (e.g. payload, size, timestamp etc.) from the data packets. In other embodiments, the function 116 is configured to utilize these metadata values extracted from the packets to generate the flow log based on a predefined schema.

In an embodiment, an example generated flow log record includes an instance identification of a resource 210, a network interface number 220, a source IP address 230, a destination IP address 240, a source port number 250, a destination port number 260, and an indicator 270. In an embodiment, the indicator 270 indicates whether network access is allowed.

In some embodiments, an instance identification 210 of a resource is an identifier of a virtual instance deployed in a computing environment. A network interface identifier 220 is a universal unique identifier (UUID) for which flow logs are collected, in an embodiment. In some embodiments, a source IP address 230 identifies incoming traffic, or the Internet Protocol version 4 (IPv4) address of the network interface for outgoing traffic. In various embodiments, a destination IP address 240 is the destination address for outgoing traffic, or the IPv4 address of the network interface for incoming traffic.

In certain embodiments, a source port number 250 is the source port from which the network flow originated. In an embodiment, the destination port 260 is the destination port to which the network flow is designated. In certain embodiments, the flow log includes an indication of network traffic acceptance 270. For example, in an embodiment, the term “ACCEPT” indicates that the network traffic is accepted by the firewall. In another example, the term “REJECT” indicates that the network traffic was rejected by the firewall.

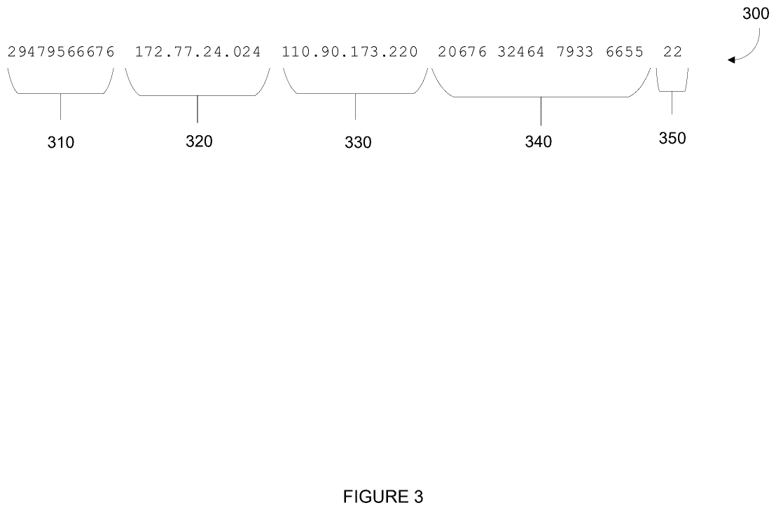

FIG. 3 is an example merged data record 300 of an aggregated flow log generated by a flow log aggregator, implemented in accordance with an embodiment. In an embodiment, the flow log aggregator (FIG. 1, 120) is configured to generate aggregated flow log records based on merged records from detected flow log records in the log 118 repository. In some embodiments, the flow log aggregator (FIG. 1, 120) is configured to access flow log records in the log 118 repository and detect flow log records that can be merged. For example, a first flow log record and a second flow log record can be merged to generate a merged log record based on a heuristic.

In an embodiment, the flow log aggregator (FIG. 1, 120) is configured to determine that the flow log records should be merged in response to detecting common data record values between multiple flow log records. In certain embodiments, the flow log aggregator (FIG. 1, 120) is configured to generate a merged record for detected flow logs with common data record values. In an embodiment, the flow log aggregator (FIG. 1, 120) is configured to generate an aggregated flow log based on the merged records that include the common data record values.

In an embodiment, an example aggregated flow log includes a merged data record 300 including an account identification of resource 310, a source IP address 320, a destination IP address 330, an array of source port numbers 340, and a destination port number 350. In some embodiments, an account identification of resource 310 is a unique identifier of a resource, of an account in a cloud computing environment in which a resource is deployed, and the like.

According to an embodiment, a source IP address 320 identifies incoming traffic, such as the IPv4 address of the network interface for outgoing traffic, in an embodiment. In various embodiments, a destination IP address 330 is the destination address for outgoing traffic, e.g., the IPv4 address of the network interface for incoming traffic.

In an embodiment, an array of source ports 340 include source port values that have been aggregated from a plurality of flow logs. For example, in an embodiment, in an embodiment, port ‘20676’ is associated with a first record, port ‘32464’ is associated with a second record, etc. In some embodiments, an aggregated array (e.g., an array into which multiple data values are stored) is fixed size, unfixed size, etc. In certain embodiments, the array size is fixed based on a number of bytes, a number of values, a number of characters, a combination thereof, and the like. A destination port number 350 is the destination port from which the network flow originated, in an embodiment.

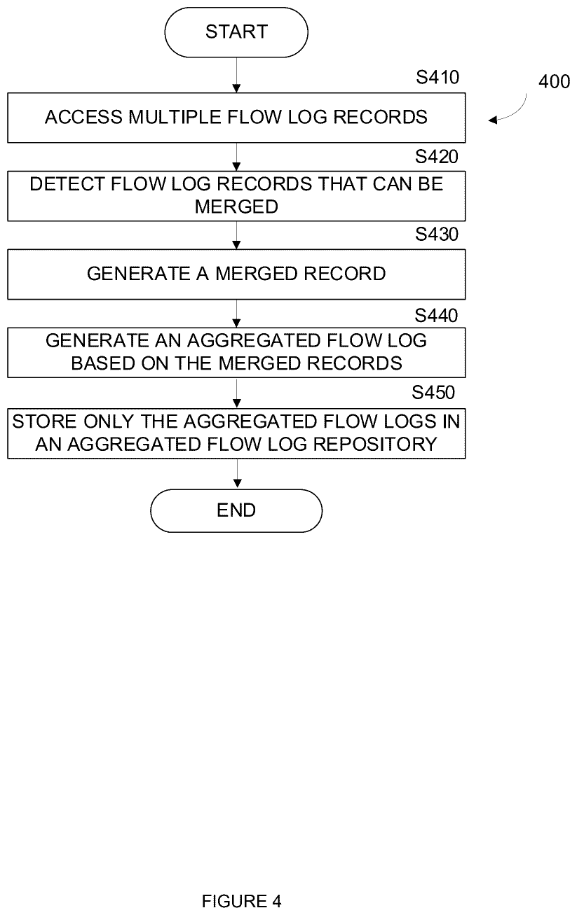

FIG. 4 is an example flowchart 400 of a method for generating and storing an aggregated flow log, implemented in accordance with an embodiment.

At S410, multiple flow log records are accessed. In an embodiment, flow log records are generated by a serverless function (e.g., of FIG. 1, 116). In an embodiment, the function is configured to generate flow logs based on data from communication traffic, including events, messages, detected event history within a specified time frame, and the like.

In some embodiments, the log is generated based on data, events, messages, and the like, from communication traffic going to and from network interfaces in a VPC. In an embodiment, a flow log aggregator is configured to access the flow log records in a log repository. For example, in an embodiment, an aggregator is provided with credentials to access a repository, such as a bucket, Cloudtrail, etc., where log records are stored.

At S420, mergeable flow log records are detected. In various embodiments, the flow log aggregator is configured to detect flow log records in the log repository. In some embodiments, the aggregator is configured to utilize a heuristic, a data matching pattern technique, and the like, to detect data record values of a first flow log record correspond to data record values from a second flow log record.

In an embodiment, where a match of data record values is detected between multiple flow log records in the log repository, a merged data record is generated. For example, in an embodiment, the flow log aggregator is configured to detect flow log records that are merged based on matching data record value of any one of: a source IP, a destination IP, a protocol, a port number, an Elastic Network Interface, an Instance ID, a combination thereof, and the like.

According to an embodiment, a first value of a data field of a first record matches a second value of the data field of a second record in response to detecting a full match between the values, a partial match between the values, etc. For example, in an embodiment, a heuristic specifies that a first value of a destination IP matches a second value of the destination IP where the first three fields of the IP address match. In such an embodiment, a record having a destination “10.0.0.100” will match a record having a destination “10.0.0.1”.

At S440, a merged record is generated. In an embodiment a merged record is generated by a flow log aggregator in response to detecting a common data record value. In some embodiments, a common data record value is a corresponding data record value between a first flow log record and a second flow log record. For example, in an embodiment where a first flow log record and a second flow log record both have a source IP of 240.700.42.007, then the common data record value is 240.700.42.007.

At S440, an aggregated flow log is generated based on the merged records. In an embodiment, a merged record includes common data record values of detected flow logs from the log repository. The flow log aggregator is configured to generate an aggregated flow log based on a plurality of merged records, such that each merged record aggregates the common data values of multiple detected flow log records.

In some embodiments, an aggregated flow log includes a data record having an account identification of a resource, a source IP address, a destination IP address, an array of port source values, and a destination port value 350. In certain embodiments, the aggregated flow log includes a plurality of merged data records, and a data record which is not a merged data record.

At S450, the aggregated flow log is stored in a repository. In an embodiment, only an aggregated flow log is stored in a database, data lake, data warehouse, and the like. In some embodiments, the database is a cloud database which is a database that runs on a public or hybrid cloud computing platform. Cloud databases are hosted on servers maintained by cloud service providers such as AWS, Microsoft® Azure, Google Cloud Platform®, and the like. Cloud databases are managed by database-as-a-service (DBaaS) or deployed in a cloud-based virtual machine (VM). In other embodiments, the database utilizes a Snowflake® platform, and the like platforms which are designed for cloud environments and leverage the storage and computing power of cloud infrastructure and further utilizes a unique SQL query engine.

In an embodiment, the aggregated log include only aggregated records (e.g., merged records). In some embodiments, certain records are filtered from the flow log. For example, in certain embodiments, a record including a value of a date field, which is a predetermined value, is excluded from being a merged record. In an embodiment, a record having an “ERROR” indicator, for example, is excluded from the merging process.

In some embodiments, certain data records are filtered based on predetermined rules, and such data records are not utilized to generate merged data records, and further are not stored in the aggregated log.

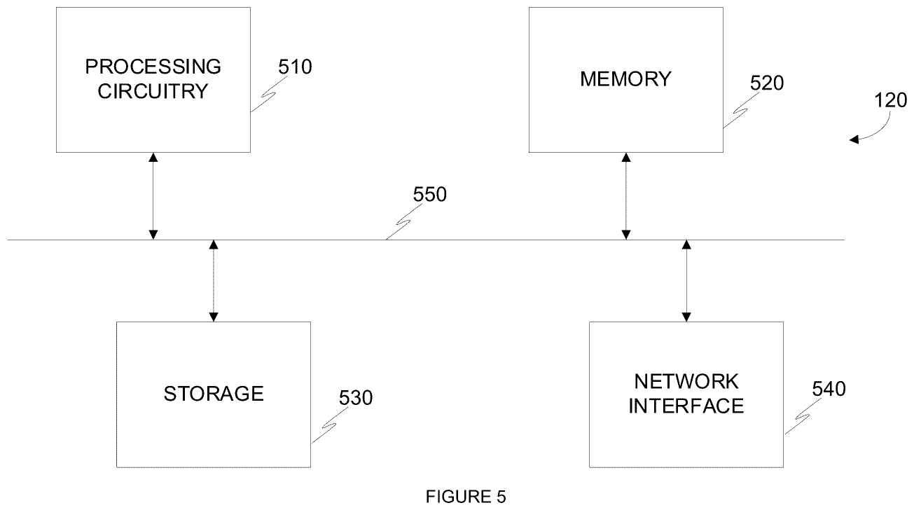

FIG. 5 is an example schematic diagram of a flow log aggregator (FIG. 1, 120) according to an embodiment. The flow log aggregator 120 includes, according to an embodiment, a processing circuitry 510 coupled to a memory 520, a storage 530, and a network interface 540. In an embodiment, the components of the flow log aggregator 120 are communicatively connected via a bus 550.

In certain embodiments, the processing circuitry 510 is realized as one or more hardware logic components and circuits. For example, according to an embodiment, illustrative types of hardware logic components include field programmable gate arrays (FPGAs), application-specific integrated circuits (ASICs), Application-specific standard products (ASSPs), system-on-a-chip systems (SOCs), graphics processing units (GPUs), tensor processing units (TPUs), Artificial Intelligence (AI) accelerators, general-purpose microprocessors, microcontrollers, digital signal processors (DSPs), and the like, or any other hardware logic components that are configured to perform calculations or other manipulations of information.

In an embodiment, the memory 520 is a volatile memory (e.g., random access memory, etc.), a non-volatile memory (e.g., read only memory, flash memory, etc.), a combination thereof, and the like. In some embodiments, the memory 520 is an on-chip memory, an off-chip memory, a combination thereof, and the like. In certain embodiments, the memory 520 is a scratch-pad memory for the processing circuitry 510.

In one configuration, software for implementing one or more embodiments disclosed herein is stored in the storage 530, in the memory 520, in a combination thereof, and the like. Software shall be construed broadly to mean any type of instructions, whether referred to as software, firmware, middleware, microcode, hardware description language, or otherwise. Instructions include, according to an embodiment, code (e.g., in source code format, binary code format, executable code format, or any other suitable format of code). The instructions, when executed by the processing circuitry 510, cause the processing circuitry 510 to perform the various processes described herein, in accordance with an embodiment.

In some embodiments, the storage 530 is a magnetic storage, an optical storage, a solid-state storage, a combination thereof, and the like, and is realized, according to an embodiment, as a flash memory, as a hard-disk drive, another memory technology, various combinations thereof, or any other medium which can be used to store the desired information.

The network interface 540 is configured to provide the flow log aggregator 120 with communication with, for example, the log 118, according to an embodiment.

It should be understood that the embodiments described herein are not limited to the specific architecture illustrated in FIG. 5, and other architectures may be equally used without departing from the scope of the disclosed embodiments.

Furthermore, in certain embodiments the flow log aggregator 120, the database 130, the log 118, the function 116, the first resource 112, the second resource 114, a combination thereof, and the like, may be implemented with the architecture illustrated in FIG. 5. In other embodiments, other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more processing units (“PUs”), a memory, and input/output interfaces. The computer platform may also include an operating system and microinstruction code. The various processes and functions described herein may be either part of the microinstruction code or part of the application program, or any combination thereof, which may be executed by a PU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

1. A method for generating and storing an aggregated flow log comprising:
accessing a plurality of flow log records in a flow log repository;
detecting a plurality of flow log records in the flow log repository, wherein each flow log record includes a plurality of data fields;
detecting a first flow log record of the plurality of flow log records having a first data field value in common with a second flow log record;
detecting in the first flow log record a second data field having a second value;
detecting in the second flow log record the second data field having a third value different from the second value;
generating a merged record based on: the first data field value and including at least the second value and the third value;
generating an aggregated flow log based on the merged record, wherein the aggregated flow log includes a plurality of merged records; and
storing the aggregated flow log in an aggregated flow log repository.

2. The method of claim 1, further comprising:
matching a data record value of the first flow log record to a corresponding data record value of another flow log record to detect a common data field value.

3. The method of claim 1, further comprising:
generating a merged record in response to detecting at least one common data record value between a plurality of flow log records from the flow log repository.

4. The method of claim 1, further comprising:
generating an aggregated flow log that includes common data record values from the merged records.

5. The method of claim 1, wherein the first data field includes any one of: an account identifier, a source address, a protocol, a destination address, a source port, a destination port, a network interface, an instance identification log status, an indicator of whether a network traffic was accepted or rejected, a subnet identifier, and any combination thereof.

6. The method of claim 1, further comprising:
detecting a flow log record that is based on any one of: a data record, a network traffic event, a message, an action in a virtual private cloud environment, and any combination thereof.

7. The method of claim 1, further comprising:
generating the aggregated flow log based on a plurality of merged records, wherein a first merged record is generated from a first flow log and a second merged record is generated from a second flow log.

8. The method of claim 1, further comprising:
determining that a first data field value is common in response to detecting at least a partial match between a value of the first flow log record and a value of the second flow log record.

9. The method of claim 1, further comprising:
filtering out a portion of records of the plurality of data records based on a value of a data field; and
generating the aggregated flow log based on the merged record without the filtered portion of records.

10. A non-transitory computer-readable medium storing a set of instructions for generating and storing an aggregated flow log, the set of instructions comprising:
one or more instructions that, when executed by one or more processors of a device, cause the device to:
access a plurality of flow log records in a flow log repository;
detect a plurality of flow log records in the flow log repository, wherein each flow log record includes a plurality of data fields
detect a first flow log record of the plurality of flow log records having a first data field value in common with a second flow log record
detect in the first flow log record a second data field having a second value
detect in the second flow log record the second data field having a third value different from the second value;
generate a merged record based on: the first data field value and including at least the second value and the third value;
generate an aggregated flow log based on the merged record, wherein the aggregated flow log includes a plurality of merged records; and
store the aggregated flow log in an aggregated flow log repository.

11. A system for generating and storing an aggregated flow log comprising:
one or more processors configured to:
access a plurality of flow log records in a flow log repository;
detect a plurality of flow log records in the flow log repository, wherein each flow log record includes a plurality of data fields;
detect a first flow log record of the plurality of flow log records having a first data field value in common with a second flow log record;
detect in the first flow log record a second data field having a second value;
detect in the second flow log record the second data field having a third value different from the second value;
generate a merged record based on: the first data field value and including at least the second value and the third value;
generate an aggregated flow log based on the merged record, wherein the aggregated flow log includes a plurality of merged records; and
store the aggregated flow log in an aggregated flow log repository.

12. The system of claim 11, wherein the one or more processors are further configured to:
match a data record value of the first flow log record to a corresponding data record value of another flow log record to detect a common data field value.

13. The system of claim 11, wherein the one or more processors are further configured to:
generate a merged record in response to detecting at least one common data record value between a plurality of flow log records from the flow log repository.

14. The system of claim 11, wherein the one or more processors are further configured to:
generate an aggregated flow log that includes common data record values from the merged records.

15. The system of claim 11, wherein the first data field includes any one of:
an account identifier, a source address, a protocol, a destination address, a source port, a destination port, a network interface, an instance identification log status, an indicator of whether a network traffic was accepted or rejected, a subnet identifier, and any combination thereof.

16. The system of claim 11, wherein the one or more processors are further configured to:
detect a flow log record that is based on any one of:
a data record, a network traffic event, a message, an action in a virtual private cloud environment, and any combination thereof.

17. The system of claim 11, wherein the one or more processors are further configured to:
generate the aggregated flow log based on a plurality of merged records, wherein a first merged record is generated from a first flow log and a second merged record is generated from a second flow log.

18. The system of claim 11, wherein the one or more processors are further configured to:
determine that a first data field value is common in response to detecting at least a partial match between a value of the first flow log record and a value of the second flow log record.

19. The system of claim 11, wherein the one or more processors are further configured to:
filter out a portion of records of the plurality of data records based on a value of a data field; and
generate the aggregated flow log based on the merged record without the filtered portion of records.
